(19) United States
(12) Patent Application Publication
(10) Pub. No.: US 2007/0048535 A1
(43) Pub. Date: Mar. 1, 2007

(54) Method for forming a protective layer on a metallic turbine substrate

(75) Inventors: Claudio Badini, Torino (IT); Paolo Fino, Torino (IT); Sara Biamino, Asti (IT); Silvia Sabbadini, Torino (IT); Giovanni Zanon, Rivalta Di Torino (IT)

Correspondence Address: DARBY & DARBY P.C., P. O. BOX 5257, NEW YORK, NY, 10150-5257, US

(73) Assignee: AVIO S.p.A., Torino (IT)

(21) Appl. No.: 11/316,218

(22) Filed: Dec. 21, 2005

(30) Foreign Application Priority Data
Jan. 11, 2005 (IT) TO2005A000008

(51) Int. Cl. B05D 3/02; B32B 15/04

(52) U.S. Cl. 428/469; 427/372.2; 428/472

(57) ABSTRACT

Method for forming a protective layer on a metallic turbine substrate, comprising the steps of: preparing an aqueous solution comprising a first component comprising a soluble salt or alkoxide; dissolving in the solution a second component based on an organic substance comprising a carbonyl group or an amine group; bringing the solution into contact with the metallic substrate; and heating the metallic substrate to a temperature in the range from 300° C. to 800° C. to form a layer of oxide on the metallic substrate. The first component is preferably a nitrate. The second component is preferably selected from the group consisting of urea, amino-acids, organic acids, hydrazine and its derivatives, azine and its derivatives, amines and mixtures of these.

The present invention relates to a method for forming a protective layer with the functions of protecting against oxidation and corrosion and acting as a thermal barrier on a metallic turbine substrate, and also relates to the metallic turbine substrate produced by means of the method.

### BACKGROUND OF THE INVENTION

The turbines used in the aerospace field are subjected to considerable thermal stresses due to the high temperatures of 1400° C. and above reached by the combustion products formed in turbine engines. If such temperatures are reached, the metallic components of the turbine, particularly the blades, which generally consist of nickel based superalloys, can be subject to structural deformation and corrosion and oxidation phenomena which may adversely affect their operation.

There is a known way of forming a protective layer on the surfaces of the metallic components, to act as a thermal barrier in order to protect the turbines from the high operating temperatures.

At the present time, the known and widely used processes for forming a protective layer are called “Air Plasma Spraying”, also known by the acronym “APS”, and referred to in this way in the following text, and “Electronic Beam Physical Vapour Deposition”, also known by the acronym “EB-PVD” and referred to in this way in the following text.

In the APS method, a flow of a first inert gas, for example argon, is made to contact the surfaces of electrodes which cause the gas to become ionized. the ionized gas thus produced, also called “plasma”, is sprayed into a chamber into which is simultaneously introduced, through an inlet tube, the powder of the material which is to form the protective layer, suspended in a flow of a second inert gas. When the high-temperature plasma comes into contact with the powder, it fuses the latter to form droplets. The droplets produced in this way are sprayed on to the surface to be coated.

This deposition method enables protective layers with very low heat conduction to be obtained, but, owing to the structure of the material forming the protective layer, has a very low resistance to thermal fatigue by comparison with thermal barriers produced by the EB-PVD method; indeed, it tends to crumble if repeatedly subjected to high temperatures.

Moreover, the APS method provides good results only if the protective layer is applied to surfaces with a high degree of roughness.

In the EB-PVD method, the material which is to constitute the protective layer is in the form of powder placed in a crucible, or is in ingot form. By means of a gun which produces high-energy electron beams, the material is vaporized by the electron beams and then condensed on the surface to be coated.

This method yields protective layers having characteristics which are the opposite of those obtained by the APS method, and indeed these layers have high resistance to both thermal and mechanical stress, but also have high thermal conductivity. A further disadvantage of this deposition method lies in the very high costs of the equipment used. Finally, both the APS and the EB-PVD method generate protective layers with a coarse structure; in other words, under micrographic examination they are found to have large particle sizes and, owing to the procedure by which the deposition is carried out, they cannot be used to produce protective layers on any microcavities or nonuniformities which may have formed on the metallic substrate.

### SUMMARY OF THE INVENTION

The object of the present invention is therefore to provide a method for forming a protective layer which resolves the problems described above. In particular, it would be preferable to find a method for depositing a protective layer which resists not only high temperatures but also mechanical stresses, while having low thermal conductivity and being reliable and inexpensive.

According to the present invention, this object is achieved by means of a method for forming a protective layer on a metallic turbine substrate according to the attached claims.

### DETAILED DESCRIPTION OF THE INVENTION

The method according to the present invention can be used to obtain a protective layer which provides thermal protection, consisting of a porous ceramic material based on pure or mixed ceramic oxides. Preferably, the protective layer comprises an oxide selected from the group consisting of ZrO₂, ZrO₂+Y₂O₃, ZrO₂+CaO, Al₂O₃, Al₂O₃+SiO₂, Al₂O₃+TiO₂, CeO₂, BaZrO₃, Y₃Al₅O₁₂, LaMgAl₁₁O₁₉, LaMnAl₁₁O₁₉.

Even more preferably, the protective layer comprises LaMnAl₁₁O₁₉.

In the method for forming a protective layer on a metallic turbine substrate according to the present invention, an aqueous solution is prepared, in which solution there can be easily dissolved a salt or an alkoxide having a cation which can act as a precursor, in other words which can form the ceramic oxide on the surface of the said metallic substrate.

A second component, based on an organic substance comprising a carbonyl group or an amine group, is then dissolved in the aqueous solution.

The metallic substrate is then brought into contact with the solution and heated to a temperature in the range from 300° C. to 800° C., preferably from 500° C. to 700° C., until, after the solvent has been volatilized, a strongly exothermic reaction is initiated to form a thin layer of oxide on the surface of the metallic substrate.

Preferably, the first component is an inorganic salt comprising an anion selected from the group consisting of nitrate, nitrite, sulphate, halide, acetate, carboxylate, citrate, in other words salts soluble in aqueous solutions.

Preferably, the first component comprises a nitrate.

Even more preferably, the first component is selected from the group consisting of aluminium nitrate, manganese nitrate, lanthanum nitrate, yttrium nitrate, zirconium nitrate, cerium nitrate, barium nitrate, these components being capable of forming optimal ceramic oxides on metallic substrates for turbines.

Alternatively, it is also possible to use salts which can be decomposed by heat, such as titanium oxysulphate or alkoxides, for example tetraethylorthosilicate.

Preferably, the second component, also referred to below as the sacrificial fuel, is selected from the group consisting of urea, amino-acids, organic acids, hydrazine and its derivatives, azine and its derivatives, amines and mixtures of these.

The second component is preferably urea.

A highly exothermic reaction takes place between the first component and the sacrificial fuel; if the reaction takes place between a nitrate and urea, it is of the following type:
xM(NO₃)_{y}+(3xy-y)/3CO(NH₂)₂ →
→MₓO_{y}+(3xy-y)/3CO₂+(9xy-2_{y})/6N₂+(6xy-2y)/3H₂O
where M is the precursor of the oxide which is to be formed as the protective layer on the metallic substrate.

If the salts used as the first component are nitrates of Zr, La and Al, the reaction becomes:
ZrO(NO₃)₂+5/3CO(NH₂)₂ →ZrO₂+5/3CO₂+16/3N₂+10/3H₂O
La(NO₃)₃+Mn(NO₃)₂+11Al(NO₃)₃+95/3CO(NH₂)₂→
→LaMnAl₁₁O₁₉+95/3CO₂+152/3N₂+190/3H₂O

The reaction, which is thermally initiated, is self-sustaining because of the high exothermicity and is completed in a few tenths of a second with the formation of the solid ceramic product and the emission of gaseous species such as CO₂, H₂O and N₂. The sacrificial fuel can undergo partial thermal decomposition before the initiation of the main reaction with the formation of products which react with the salts by secondary reactions, which in all cases lead to the formation of the solid ceramic product and gaseous species such as CO₂, H₂O, N₂, and nitrogen oxides.

The solution can also comprise a third component acting as an adjuvant, for example ammonium nitrate, which reacts exothermically with the sacrificial fuel to increase both the temperature and the quantity of gas emitted.

Preferably, the adjuvant reaction takes place with urea, and in particular, if the adjuvant is ammonium nitrate, the following reaction takes place:
3NH₄NO₃+CO(NH₂)₂→CO₂+4N₂+8H₂O

The presence of ammonium nitrate may require the use of additional quantities of fuel, not necessarily in a stoichiometric quantity, because any excess ammonium nitrate, as well as any excess fuel, is removed during synthesis by the decomposition and formation of gaseous products. The sacrificial fuel is therefore used in a stoichiometric quantity to react directly with the precursor salts or in a substoichiometric or superstoichiometric quantity, provided that it is sufficient to initiate and complete the process. The dimensions of the oxide particles forming the metallic layer and the corresponding degree of porosity will vary according to the proportions of salt to fuel and any adjuvant used.

The method for forming the protective layer according to the invention is preferably applied at atmospheric pressure and the reaction takes place at a temperature in the range from 300° C. to 800° C., a range in which the initiation takes place and leads to the formation of the oxides which form the protective layer.

To achieve optimal results, the surface of the metallic substrate to be coated can be cleaned beforehand, by sandblasting for example, to promote the adhesion of the protective layer to the metallic substrate, and pre-heated before being brought into contact with the solution containing the reagents.

Advantageously, the step of bringing the solution into contact with the metallic substrate can be carried out by spraying with a spray gun, or by impregnation.

Generally, the sequence of steps of the method starts with the cleaning of the surface of the metallic component and then comprises a step of pre-heating the component in a furnace and the subsequent deposition of the reagent solution on the surface. After this, the substrate is kept in the furnace until the reaction is complete. The substrate is then taken out and blown with compressed air to remove any of the ceramic product which has not adhered sufficiently to the surface.

The protective layer which is obtained is generally very thin, with a thickness of approximately 5 μm for example, but the deposition of the protective layer can be repeated a number of times in an automatic way to produce final protective layers of the desired thickness, preferably in the range from 100 μm to 200 μm.

An examination of the characteristics of the method according to the present invention will clearly reveal the advantages which it provides.

In particular, this method can advantageously be used to deposit protective layers which may be either amorphous or crystalline, in which the particle sizes are of the order of microns or of the order of nanometres. Advantageously, the crystalline states are not subject to devitrification processes, with possible dimensional variations, when the component operates at high temperatures. The method can also be used for the deposition of protective layers generated by the successive deposition of a plurality of layers which may have different chemical compositions. Furthermore, the reaction conditions maintained during the process, the separation of the molecules of the reagents in the solution, the rapidity of the synthesis, and the evolution of considerable quantities of gas lead to the production of particles even down to nanometric sizes and enable the degree of porosity of the protective layer to be controlled.

Even more advantageously, the deposition method according to the present invention can be used to obtain a protective layer with a very fine and uniformly distributed porosity, which has excellent characteristics in respect of thermal insulation.

Advantageously, by varying the operating conditions of the illustrated method, for example by varying the temperature and the quantity of sacrificial fuel and ammonium nitrate, it is possible to obtain powders having a surface area varying in the range from 3 to 300 m²/g.

Advantageously, the deposition method according to the invention is also applicable to excessively large pores or to cavities which are formed accidentally in the first steps of production of the substrate.

Advantageously, the method according to the invention can also be used at temperatures which do not damage the structure of the metallic substrate.

Finally, the method according to the invention requires the use of very simple and economical equipment, such as a chamber furnace with resistors as the heating elements, and is therefore much more economical than known deposition methods. The method allows the introduction of further accessory thermal treatments, both in the intermediate steps of the deposition and at the end of this process. These treatments may have the purpose of crystallizing the deposited ceramic material, sintering the protective layer and improving the interface bond with the metallic substrate.

A crystallization treatment can be useful for stabilizing the structure of the surface layer, thus preventing the occurrence of structural and dimensional changes during service life. For example, LaMnAl₁₁O₁₉ deposited by the APS method is amorphous in nature and, if subsequently heated, shows the formation of large cavities and a decrease in mechanical strength because of the shrinkage caused by crystallization. The method which has been developed has the advantage of being able to eliminate the cavities due to crystallization and to consolidate the protective layer with further depositions.

The porosity of the layer can be decreased further by a final sintering treatment.

A final thermal treatment can improve the interface, bond between the protective layer and the substrate by the activation of diffusion processes.

The temperatures to be used for crystallization, sintering and diffusion depend on the type of ceramic material forming the protective layer and can be specified from time to time, the only limitation being the maximum temperature which the substrate can withstand.

Finally, the method according to the invention can easily be automated; this is because the component can be moved continuously through a series of stations which carry out the successive steps of the method, namely the pre-heating step, the spraying of the solution, the reaction and the blowing. Lastly, the series of stations can be joined up to form a cycle.

Further characteristics of the present invention will be made clear by the following description of an example, provided solely for illustrative purposes and without restrictive intent, of a method for depositing a protective layer of lanthanum hexaluminate.

The first step is to form a solution containing:
7.36 g of aluminium nitrate;
0.33 g of manganese nitrate;
0.54 g of lanthanum nitrate;
3.24 g of urea, and
5 ml of water.

The solution produced in this way is sprayed, until complete wetting is achieved, on to a metallic substrate pre-heated in a furnace programmed to a constant temperature of 600° C. The metallic substrate treated in this way is placed back in the furnace at 600° C. for two minutes. The metallic substrate is then taken out of the furnace and blown with compressed air so as to remove the excess material, in other words that which has not adhered to the said metallic substrate. The procedure is repeated 20 times to produce a protective layer with a thickness of 100 μm.

1. Method for forming a protective layer on a metallic turbine substrate, comprising the steps of:
preparing an aqueous solution comprising a first component comprising at least a salt or an alkoxide, at least partially soluble in water;
dissolving in said aqueous solution an organic substance comprising a carbonyl group or an amine group;
bringing the metallic substrate into contact with the solution;
heating the metallic substrate to a temperature in the range from 300° C. to 800° C. to form an oxide on the surface of the said metallic substrate.

2. Method according to claim 1, wherein the organic substance comprises at least one substance selected from the group consisting of urea, amino-acids, organic acids, hydrazine and its derivatives, azine and its derivatives, and amines.

3. Method according to claim 1, wherein the organic substance is urea.

4. Method according to claim 1, wherein the aqueous solution comprises ammonium nitrate as the third component.

5. Method according to claim 1, wherein the first component is a salt having an anion selected from the group consisting of nitrate, nitrite, sulphate, halide, acetate, carboxylate and citrate.

6. Method according to claim 5, wherein the first component is a salt having a nitrate as its anion.

7. Method according to claim 6, wherein the nitrate salt comprises an element selected from the group consisting of aluminium, manganese, lanthanum, zirconium, cerium, barium and yttrium.

8. A Metallic turbine substrate, having a protective layer comprising a ceramic oxide produced according to claim 1.

9. A Metallic substrate according to claim 8, wherein the protective layer comprises an oxide selected from the group consisting of ZrO₂, ZrO₂+Y₂O₃, ZrO₂+CaO, Al₂O₃, Al₂O₃+SiO₂, Al₂O₃+TiO₂, CeO₂, BaZrO₃, Y₃Al₅O₁₂, LaMgAl₁₁O₁₉, LaMnAl₁₁O₁₉.

10. A Metallic substrate according to claim 9, wherein the protective layer is based on LaMnAl₁₁O₁₉.
